(19) United States
(12) Patent Application Publication
(10) Pub. No.: US 2025/0174091 A1
(43) Pub. Date: May 29, 2025

(54) ELECTRONIC PRINTERLESS TICKET ISSUANCE SYSTEM AND METHOD OF USE

(71) Applicant: Sticky Tickets, Inc., Chattanooga, TN (US)

(72) Inventors: Dustin Bowe, Hixson, TN (US); Britton Stansell, Chattanooga, TN (US)

(73) Assignee: Sticky Tickets, Inc., Chattanooga, TN (US)

(21) Appl. No.: 18/519,980

(22) Filed: Nov. 27, 2023

(51) Int. Cl. G07F 17/42; G06Q 10/02; H04L 67/306

(52) U.S. Cl. CPC G07F 17/42; G06Q 10/02; H04L 67/306

(57) ABSTRACT

A method for operating a ticketing system, wherein tickets including human-readable content and machine-readable content and a unique identifier are provided to a ticket user in a physical format. A computer-based platform is accessible to user devices over a network and is associated with electronic storage that stores information of ticket users, ticket clients and tickets. If a user issues a ticket, the platform creates or updates a client record that associates client information collected by the user with a unique identifier and updates a user record. The ticket is issued without requiring modification of the pre-printed information or modification of a physical format of the ticket with other than pre-printed information. Then, in response to (i) a portion of the ticket being imaged by a user device or (ii) the unique identifier being input into the platform with a user device, a portion of the client record is displayed on a user device.

### FIELD

The present disclosure generally relates to systems and methods of printing, issuing, and tracking tickets pre-printed with human-readable content and machine-readable content without requiring modification of the pre-printed information or modification of a physical format of the tickets with other than pre-printed information.

### BACKGROUND

Tickets are ubiquitous. Tickets are used to grant access to events or facilities (sometimes referred to, collectively, as “controlled spaces”). For example, tickets are often used for admission to controlled spaces such as amusement parks and concerts, as boarding passes for airlines, as meal vouchers, etc. Tickets are also used as an enforcement mechanism for discouraging or penalizing certain acts, including in controlled spaces, such as improperly parking or improperly remaining parked in a reserved parking space or parking lot. However, there are several issues associated with the current methods of printing, issuing, and tracking tickets. Since the parking industry, alone, is a multi-billion-dollar industry in the US, it would be advantageous to improve these methods. Other ticket-based industries would also benefit from improvements to these methods as well.

There are millions of controlled spaces in the U.S., including metered parking spaces, garages, parking areas/lots, etc. Each of these controlled spaces represents value and its value is maximized by maximizing the amount of time that each space is occupied by a paying client (e.g., a vehicle occupying a paid-up space in a parking lot). When non-paying clients and holdover clients (e.g., vehicles that remain parked after their allotted time ends) occupy a controlled space, the efficiency and value of the space is reduced. However, monitoring a large number of controlled spaces, identifying and addressing holdover and non-paying clients, and other maintenance tasks needed to maintain the controlled spaces can be a costly, time consuming, and occasionally difficult task that the owners of those controlled spaces would prefer to outsource to a management company.

It is often the job of such a management company to assist its clients in maximizing the value of their controlled spaces. This is accomplished by quickly addressing routine maintenance issues, maintaining problem-free access to the facility, and maximizing occupancy and payment. These tasks are often carried out by attendants that monitor the controlled spaces and address maintenance issues and that issue tickets (i.e., citations) as necessary. In many cases, especially in cases where tickets must be issued “in the field” (e.g., away from an established place of business), where computer and printing capabilities are limited, tickets are often handwritten or are printed from a mobile printer. Typically, the owner of an improperly parked vehicle is not located in or around his or her vehicle when a ticket is being issued to them. In those cases, the ticket is typically left on the windshield of the vehicle and is secured in place under one of the windshield wiper blades. If the vehicle remains improperly parked, subsequent tickets are typically issued by repeating the same process and placing these additional printed paper tickets under the windshield wiper blade of the vehicle.

This process can be improved, which could increase revenues for the owner of the controlled space and for the management company. Handwritten tickets are slow, can be hard to read and interpret, and are prone to error. On the other hand, while printed tickets are sometimes faster and are easier to read and interpret, the process of printing tickets is also not ideal. Among other things, the printer itself is a special piece of equipment that must be purchased, carried by controlled space attendants, and maintained. Therefore, if the printer loses power, or is not supplied with ink or paper, tickets cannot be issued. Additionally, the process of repeating the same exact process to issue and print a second (or subsequent) ticket is time consuming and wastes resources. Lastly, it is common for paper tickets placed under windshield wiper blades to become dislodged, damaged by the elements, or to otherwise be lost or unusable. This can lead to a loss in revenue, disputed charges, redundant work by the management company, etc.

Accordingly, for at least the reasons discussed above, there exists a need for improved systems and methods for issuing tickets using a ticket dispenser and methods for issuing and managing tickets that have been issued.

### NOTES ON CONSTRUCTION

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

As used herein, the term “ticket” includes warning, citations, alerts, notices, etc. for parking, speeding, and other violations as well as for providing information and the like. The term “ticket” also includes passes, vouchers, certificates, tokens, stubs, cards, and the like that are used to grant and/or verify a right to access or partake in events or facilities, including concerts, shows, events, other gated or protected areas, parking facilities, and the like. “Ticket” may also include other devices that grant access to other goods and/or services, such as postage or carrier charges for mail, parcels, etc.

The term “circumferentially” may mean in a circular or substantially circular direction, such as along the circumference or in a tangential direction or in a direction that is radially offset (i.e., closer or further from the center) but is parallel with a tangential direction.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing a ticket dispenser formed by a body having an internal space defined by a peripheral wall and a closed bottom located at one end of the peripheral wall, wherein the internal space is sized and configured to hold a roll of pre-printed tickets. An open top of the body is located at an end of the peripheral wall opposite the closed bottom. A cap is configured to removably mount over the open top to secure the roll of pre-printed tickets within the internal space. A slot is formed in the peripheral wall of the body and is sized and configured to permit the roll of pre-printed tickets to be unrolled within the internal space by guiding a free end of the roll of tickets through the slot.

In certain embodiments, the slot is formed by a first slot portion having a first slot surface with a first outer end and first inner end and a second slot portion having a second slot surface with a second outer end and second inner end. The first slot surface is parallel with a first plane that is oriented at a first angle with respect to a tangential plane centered between the first outer end and the second outer end. Similarly, the second slot surface is parallel with a second plane that is oriented at a second angle with respect to the tangential plane. In certain embodiments, the slot is oriented such that tickets pass out of the body via the slot by passing between the first slot surface and second slot surface at an exit angle of between 5° and 50° with respect to the tangent. In some cases, the first angle and second angle are different such that an outer slot opening size measured in a circumferential direction between the first and second outer ends is greater than an inner slot opening size measured in said circumferential direction between the first and second inner ends. In some cases, an edge of the first outer end is sharpened to facilitate separating a first ticket of the roll of pre-printed tickets from a second ticket of the roll of pre-printed tickets.

According to certain embodiments of the invention, the ticket dispenser includes an internal guide that is mounted to an inner surface of the peripheral wall. The internal guide is located proximate the slot and extends into the internal space. Preferably, the internal guide is configured such that tickets of the roll of pre-printed tickets are guided through a guide section between an inward-facing surface of the inner surface of the peripheral wall and an outward-facing surface of the internal guide and towards the slot. In certain cases, the internal guide is biased towards the inner surface of the peripheral wall to apply a compressive force to tickets passing through the guide section. In certain cases, at least one protrusion is disposed in the guide section and extends away from the internal guide or from the inner surface of the peripheral wall. The protrusion(s) is configured to contact tickets passing through the guide section. In certain preferred embodiments, three such protrusions are provided, including a pair of spaced apart protrusions that are each disposed on either the internal guide or the inner surface of the peripheral wall and a protrusion disposed between the pair of spaced apart protrusions on the other one of the internal guide or the inner surface of the peripheral wall. Tickets are compressed and securely held between these protrusions as they pass out of the slot.

In certain embodiments, a finger cutout is formed in the peripheral wall at the guide section. The finger cutout permits a user to contact a portion of a ticket passing out of the body while a portion of the ticket is in the guide section. The finger cutout is positioned over the internal guide such that the ticket passing out of the body and contacted by the user at the finger cutout is compressed against the internal guide.

In certain cases, the ticket dispenser also includes the roll of pre-printed tickets. Preferably, in such cases, each ticket is associated with a unique identifier, is in a physical format, and includes pre-printed content including human-readable content and machine-readable content. The machine-readable content is configured to cause information to be displayed on a user device when the machine-readable content of the ticket is imaged by the user device. Lastly, preferred tickets include an adhesive configured to permit the ticket to be removably attached to a surface.

The present disclosure also describes a method for operating a ticketing system. Certain methods require providing a first plurality of tickets to a ticket user in a physical format and including pre-printed content including human-readable content and machine-readable content, wherein each ticket is associated with a unique identifier. Certain methods also require providing a computer-based platform that is accessible over a network using a plurality of user devices. The platform is preferably associated with at least one electronic storage configured to store user information for one or more ticket users, client information for one or more ticket clients and ticket information for one or more tickets. Within the platform, each of the first plurality of tickets is preferably associated with a user record for the ticket user in the electronic storage.

Within the platform, in response to a user issuing a first ticket by (i) imaging at least a portion of the machine-readable content of a first ticket of the first plurality of tickets with one of the plurality of user devices or (ii) inputting the unique identifier into the platform via an input of one of the plurality of user devices and inputting client information into the platform via the input, a client record is automatically created or updated in the electronic storage. That record preferably associates at least a portion of the client information that has been input by the user with the unique identifier of the first ticket. The ticket is preferably issued without requiring modification of the pre-printed information or the physical format of the first ticket with other than pre-printed information. That information may be retrieved later. In certain cases, in response to (i) a portion of the machine-readable content of a first ticket being imaged with one of the plurality of user devices or (ii) the unique identifier being input into the platform with one of the plurality of user devices, a portion of the client record is displayed. Preferably, the client record is updated within the platform in response to a second ticket being issued that is associated with client information related to the client. In certain cases, a financial obligation is associated with the client and the client record. In such cases, the method may further involve accepting payment via the platform and then applying the payment to the financial obligation.

Next, in some cases, each of the tickets is provided in a non-activated ticket state and may be updated from the non-activated ticket state to an activated ticket state when the ticket is issued. In some cases, a count of non-activated tickets is associated with the user account, and the count of non-activated tickets is reduced each time a ticket is activated. Preferably, a second plurality of tickets is automatically provided to the ticket user in a non-activated ticket state in response to the count of non-activated tickets falling below a pre-determined minimum.

Other methods disclosed herein relate to issuing a ticket using a ticketing system. Certain methods require accessing a plurality of tickets that are provided in a physical format and that include pre-printed content including human-readable content and machine-readable content, wherein each ticket is associated with a unique identifier. Certain methods also require issuing a ticket that associates client information for a first client with the unique identifier of a first ticket of the plurality of tickets in an electronic storage by (i) imaging at least a portion of the machine-readable content of a first ticket of the first plurality of tickets with the user device or (ii) inputting the unique identifier into the platform via an input of the user device and inputting client information into the platform via the input. Issuing a ticket automatically creates or updates a client record associated with the client and the unique identifier of the first ticket and creates or updates a user record associated with the user and the unique identifier of the ticket. Preferably, the ticket is issued without requiring modification of the pre-printed information or the physical format of the first ticket with other than pre-printed information. In certain instances, each of the plurality of tickets is provided with an adhesive configured to permit the ticket to be removably attached to a surface. In such cases, the method further includes removably adhering the ticket to said surface with the adhesive.

Certain methods also include loading the first plurality of tickets into a ticket dispenser having a body with an internal space defined by peripheral wall and a closed bottom located at one end of the peripheral wall. The internal space is sized and configured to hold the first plurality of tickets. An open top of the body is located at an end of the peripheral wall opposite the closed bottom. Then, a cap may be removably mounted over the open top to secure the first plurality of tickets within the internal space. Finally, a slot is formed in the peripheral wall of the body and is sized and configured to permit the first plurality of tickets to be unrolled within the internal space by guiding a free end of the first plurality of tickets through the slot.

### BRIEF DESCRIPTION OF THE DRAWINGS

Further advantages of the invention are apparent by reference to the detailed description when considered in conjunction with the figures, which are not to scale to show the details more clearly, wherein like reference numerals represent like elements throughout the several views, and wherein:

FIG. 1 is a front perspective view of a ticket dispenser having a body and a removable cap according to an embodiment of the present invention;

FIG. 2A is a rear perspective view of the ticket dispenser shown in FIG. 1;

FIGS. 2B and 2C are side elevation views of portions of the ticket dispenser shown in FIG. 1;

FIGS. 3 and 4 are top and bottom perspective views, respectively, of the ticket dispenser of FIG. 1 and including a roll of pre-printed tickets according to an embodiment of the present invention;

FIG. 5 is an exploded view of the ticket dispenser shown in FIG. 1 and where the body is shown separated from the removable cap;

FIG. 6A is an exploded view of the ticket dispenser shown in FIG. 1 and also a roll of pre-printed tickets intended to be inserted into the body of the ticket dispenser and then covered by the cap;

FIG. 6B is a detail view of a portion of the ticket dispenser shown in FIG. 6A enclosed by a box labeled “FIG. 6B”;

FIG. 7A is a top plan view depicting an interior of the body shown in FIG. 1;

FIG. 7B is a detail view of a portion of the body shown in FIG. 7A enclosed by a box labeled “FIG. 7B”;

FIG. 7C is a detail view of protrusions formed on a portion of the body shown in FIG. 7A;

FIG. 8A is a top plan view depicting the interior of the body shown in FIG. 1 after the ticket dispenser is supplied with a roll of pre-printed tickets;

FIG. 8B is a detail view of a portion of the ticket dispenser and tickets shown in FIG. 8A;

FIG. 9 illustrates a front surface of a plurality of tickets of a roll of pre-printed tickets having pre-printed content including human-readable content and machine-readable content;

FIG. 10 illustrates a rear surface of one of the plurality of tickets shown in FIG. 9; and

FIG. 11 is a diagram illustrating a ticketing system that may be used according to the methods described herein to issue tickets using a roll of tickets having pre-printed content including human-readable content and machine-readable content without requiring modification of the pre-printed information or modification of a physical format of the tickets with other than pre-printed information.

### DETAILED DESCRIPTION

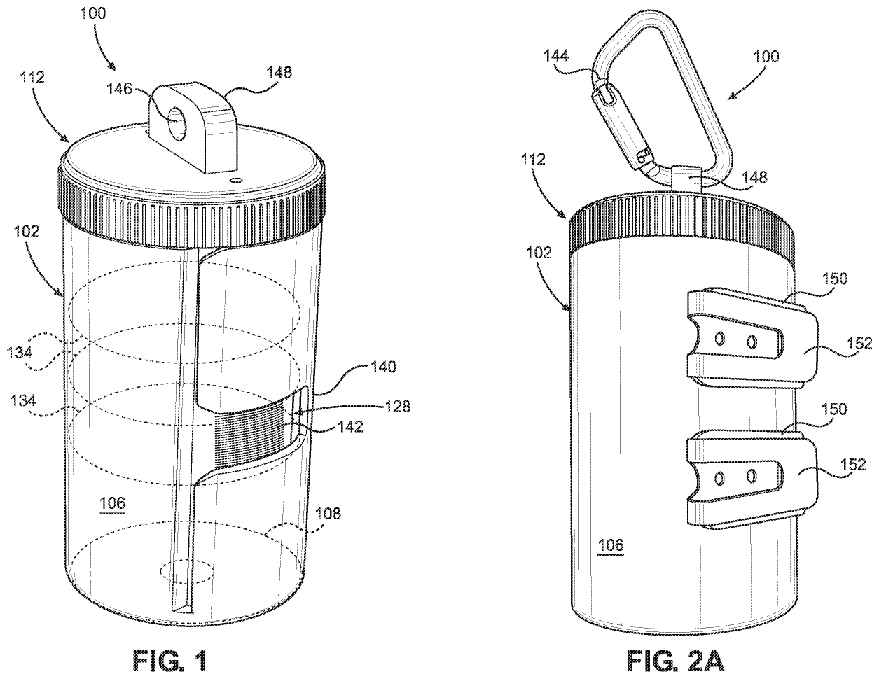

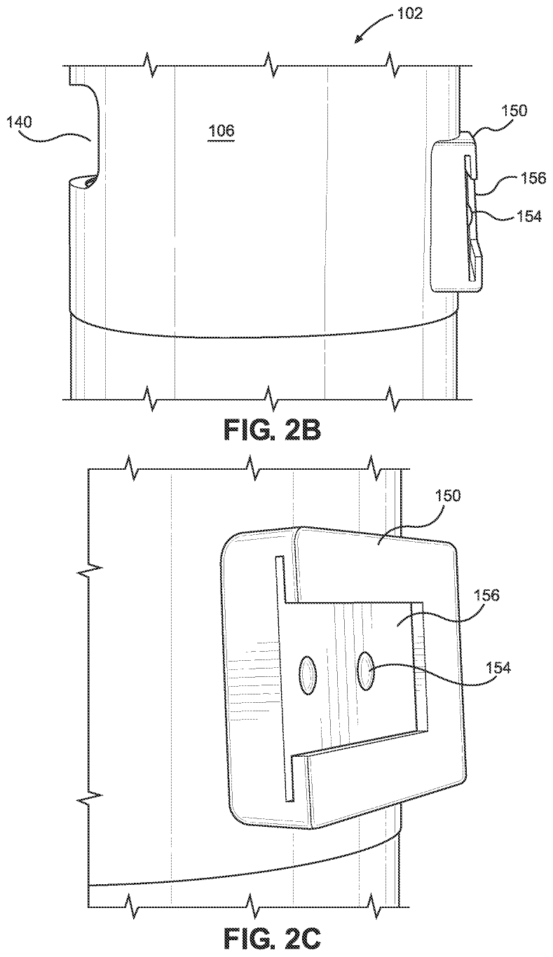

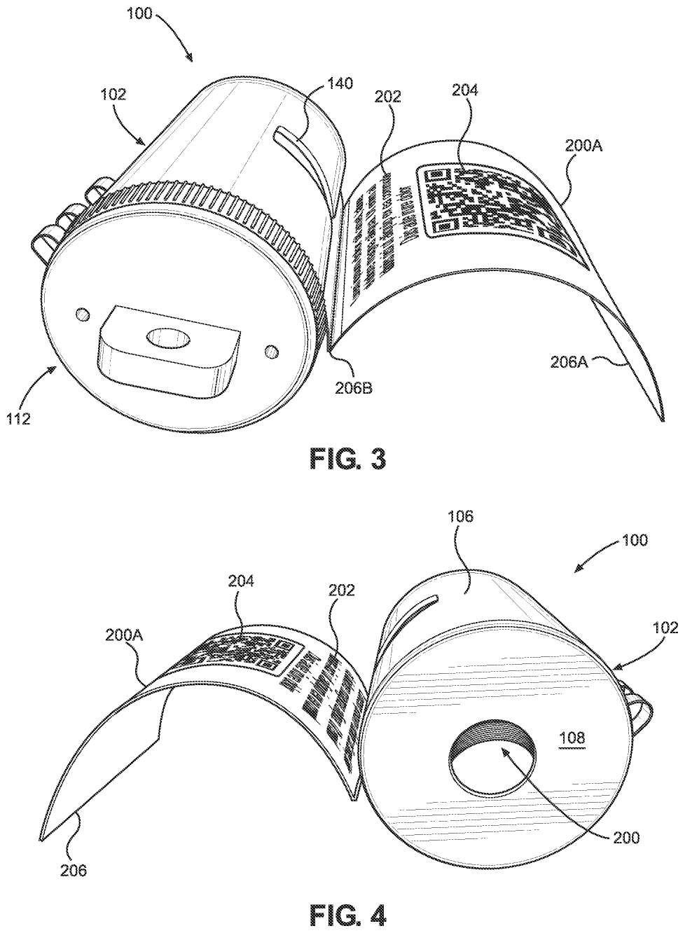

Referring now to the drawings in which like reference characters designate like or corresponding characters throughout the several views, there is shown in FIGS. 1 and 2A-2C a ticket dispenser 100 according to an embodiment of the present invention. In FIGS. 3 and 4, a dispenser 100 is shown with a roll 200 of tickets 200A that are each provided in a physical form having pre-printed content including human-readable content 202 and machine-readable content 204. As discussed further below, in preferred embodiments, the machine readable content 204, when imaged/scanned by a user device (e.g., a mobile phone), is configured to cause previously-stored information to be displayed on a user device and/or to enable information to be input and stored in association with the ticket, including information needed to issue the ticket (e.g., license plate number, VIN number, make and model, etc.) or information needed to interact with the ticket and underlying systems (e.g., paying a parking fine). In fact, the ticket 200A and all underlying or related records may preferably be updated, interacted with, etc. entirely via a user device by imaging the ticket. Further, tickets 200A may be issued and interacted with without requiring modification of the pre-printed information or the physical format of the ticket itself including by providing other information that has not been pre-printed on the ticket. In other words, unlike prior ticket delivery systems and methods, no writing or printing whatsoever is required to fully complete and issue or use tickets 200A used by this dispenser 100.

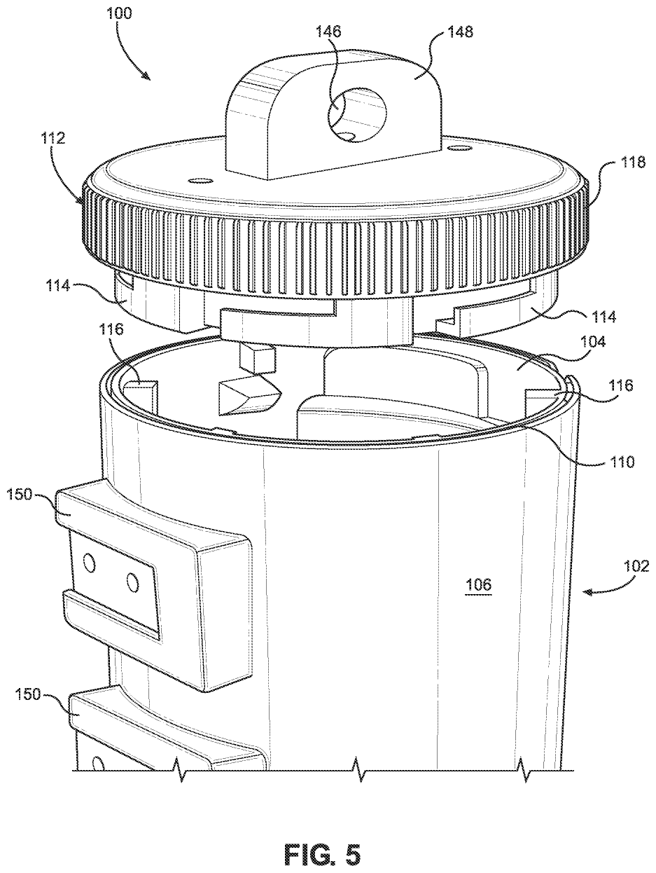

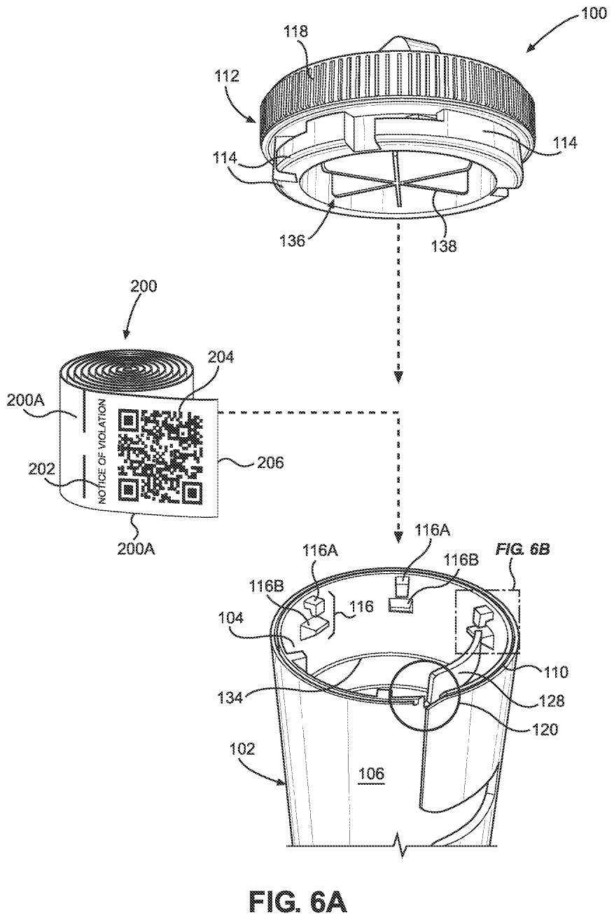

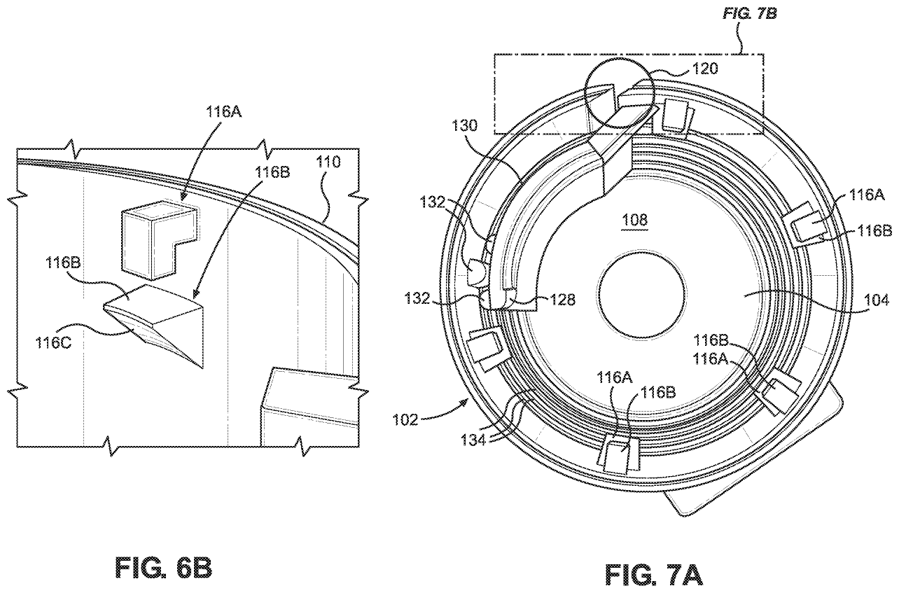

With continued reference to FIGS. 1-4 and with further reference to FIGS. 5-6B, ticket dispenser 100 is formed by a body 102 having an internal space 104 that is defined by a peripheral wall 106 that, in this case, is a cylindrical wall that provides a corresponding cylindrically-shaped internal space. The internal space 104 is sized and configured to hold the roll 200 of pre-printed tickets. The roll 200 of tickets 200A is secured within the internal space 104 by a closed bottom 108 that is located at one end of the peripheral wall 106. In the illustrated embodiment, the closed bottom 108 is formed continuously as a unitary part of the body 102. However, in other embodiments, a removable bottom may be provided instead. An open top 110 of the body 102 is preferably located at an end of the peripheral wall 106 opposite the closed bottom 108. A cap 112, such as a gasketed cap, is configured to removably mount over the open top 110 (and/or open bottom, if provided) to secure the roll 200 of pre-printed tickets within the internal space 104.

Different means for connecting removable caps, such as cap 112, to the body 102 may be used. For example, a snap or threaded connection may be used. Other connecting means known in the art may also be used. In the illustrated embodiment, several L-shaped receivers 114 are distributed around and encircle an underside of the cap 112 and a corresponding plurality of locking tabs 116 is provided on and surrounds an inside surface of the peripheral wall 106 immediately adjacent the open top 110. When the cap 112 is placed onto the body 102, the underside of the cap is sized and configured to fit within the peripheral wall 106 and each of the receivers 114 has an open end (i.e., the left end as shown in FIGS. 5 and 6) that is configured to engage with (e.g., to receive via insertion) one of the tabs 116 of the body 102. With the tabs 116 engaged with the receivers 114, twisting the cap 112 clockwise (as viewed in FIGS. 5 and 6A) with respect to the body 102 causes the tabs to slide from the open end of the receiver to a closed end located at the opposite end of the receiver, which removably locks the cap and body together. In certain embodiments, an approximate quarter turn (i.e.,) 90° is used to fully engage/fully disengage the receivers 114 and slots 116, which is faster than other forms of securement.

In certain cases, the tab and slot mechanism may include a lock (not shown), such as locking ridges, detents, etc. that are formed in or on the receivers 114, tabs 116, or both and that are used to secure them in a locked position to reduce the likelihood of the cap and body from disengaging from one another. In certain embodiments, including the illustrated embodiment, each locking tab 116 is formed by an L-shaped upper tab 116A that engages and slides along the slotted upper portion of the correspondingly L-shaped receiver 114, as discussed above, along with a lower tab 116B. In preferred embodiments, lower tabs 116B are provided with a flat and horizontal (as seen in FIG. 6B) top surface 116C that is configured to contact and provide support to a lower surface of the L-shaped receiver and to facilitate the rotation of the cap 112 with respect to the body 102. Further, in preferred embodiment, lower tabs 116B are also provided with a slanted lower surface 116B. In the illustrated case, an equal number of upper tabs 116A and lower tabs 116B is provided and each is vertically aligned with one another such that the upper and lower tabs form a vertical pair of tabs. However, in other cases, a different number, or a different placement of the tabs 116A/116B may be used. For example, in certain cases, tabs 116A/116B are offset or are provided in different numbers. In other cases, the lower tab 116B may form a continuous ring within the peripheral wall 106.

To prepare the ticket dispenser 100 for use, the internal space 104 is exposed by removing the cap 112 from the body 102. In the illustrated embodiment, twisting the cap 112 counterclockwise (as viewed in FIG. 3) will permit the tabs 116 to be disengaged from the receivers 114 and for the cap 112 to be separated from the body 102. To assist in rotating the cap 112 with respect to the body 102, an outer surface of either the cap or the body may be provided with means for increasing grip. For example, in the illustrated embodiment, a ring of spaced apart and vertically-oriented ridges 118 surrounds an outer surface of the cap 112. These ridges 118 are sized and configured to assist a user in gripping and turning the cap 112 with respect to the body 102. A roll of tickets is then placed inside of the internal space 104. The slanted lower surface 116B of the lower tab 116B assists in guiding the roll into place within the internal space 104 urges the roll towards the closed bottom 108 and away from the open top 110. Once the roll is located within the internal space 105, the cap 112 is replaced on the body 102. A slot 120 is formed in the peripheral wall 106 of the body 102 that is sized and configured to permit an end of the roll 200 of pre-printed tickets 200A to be unrolled by guiding a free end 206 through the slot.

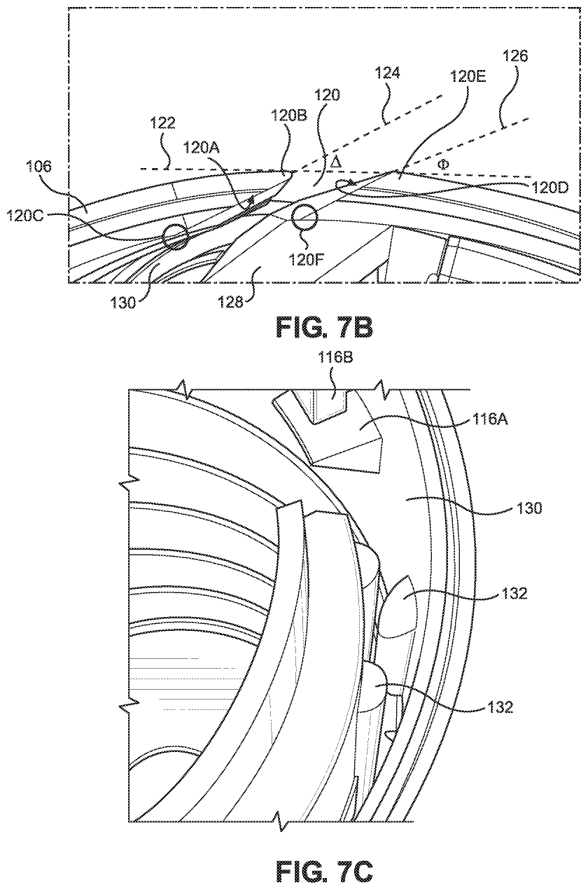

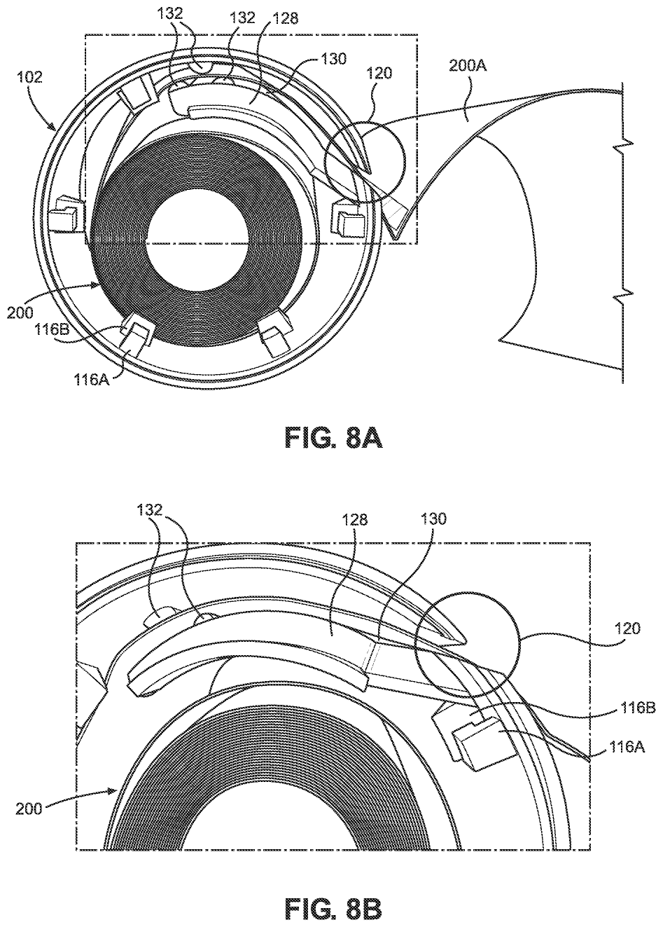

With reference to FIGS. 7A-8B, the slot 120 is formed by (i) a first slot portion having a first slot surface 120A that includes first outer end 120B, and first inner end 120C; and (ii) a second slot portion formed by second slot surface 120D that includes second outer end 120E, and second inner end 120F. Preferably, the slot 120 is configured to direct tickets out of the body 102 at an exit angle that is between angle Δ and angle Φ. Angle Δ represents the angle that is formed between a tangent plane 122 that is parallel with a tangent of the cylindrical peripheral wall 106 centered between first outer end 120B and second outer end 120E and a first plane 124 that is parallel with the first slot surface 120A. On the other hand, angle Φ represents the angle that is formed between tangent plane 122 and a second plane 126 that is parallel with the second slot surface 120D.

In various embodiments, angle Δ and angle Φ range from less than 5° to greater than 50°, from approximately 5° to approximately 50°, or from at least 5° to no more than 50°. Consequently, the exit angle of tickets passing out of the body 102 ranges from less than 5° to greater than 50°, from approximately 5° to approximately 50°, or from at least 5° to no more than 50°. In the illustrated embodiment, the exit angle is directed rightwards (as viewed in FIGS. 7A and 7B). However, in other cases, the first and second slot surface 120A, 120D are swapped and the tickets exit the body 102 in a leftward direction.

In certain embodiments, angle Δ and angle Φ are different but in other cases they are the same. In certain cases, an outer slot opening size, which is measured in a circumferential direction between the first outer end 120B and the second outer end 120E, is greater than an inner slot opening size, which is measured in a circumferential direction between the first inner end 120C and second inner end 120F. In other words, the size of the slot 120 expands as the ticket is pulled from the body 102. In other cases, the outer slot opening size is less than the inner slot opening sizes such that the size of the slot 120 contracts as the ticket is pulled from the body 102. In other embodiments, angle Δ and angle Φ are the same angle such that the first and second slot surfaces 120A, 120B are parallel to one another and parallel with the exit angle and the outer slot opening size is equal to the inner slot opening size.

As such, depending on angle Δ and angle Φ, the slot 120 may expand or contract. For example, in the illustrated embodiment, angle Δ is greater than angle Φ, such that the width of the inner end of the slot 120 (i.e., the end located closer to first inner end 120C and second inner end 120F) is narrower than the outer end of the slot (i.e., the end located to first outer end 120B and second outer end 120E). Having a widening slot may assist a user in pulling tickets through the slot in a wider range of exit angles (i.e., between angle Δ and angle Φ). For example, the dispenser 100 might be worn on a user's hip when it is in use and oriented such that the exit angle points somewhere between the horizon and the ground. A wider exit angle may give the user more flexibility in extracting tickets from the body 102 and then separating tickets from the roll of tickets. In other cases, a narrowing slot may also be provided if angle Δ is greater than angle Φ. By modifying the size (e.g., width) and angle of the slot 120, the performance characteristics of the dispenser 100 may be tailored. A wider slot and/or a widening slot opening will permit tickets to be drawn out of the body 102 more quickly, including from a wider range of positions and angles. On the other hand, a narrower slot and/or a narrowing slot opening is potentially more precise but slower.

As further discussed below, systems according to embodiments of the present invention may provide other additional (and optional) features to assist in quickly and correctly placing the tickets into the body 102 and dispensing and separating one ticket from the remaining roll of tickets.

First, an internal guide 128 is mounted to and extends away from an inner surface of the peripheral wall 106 into the internal space 104. In certain embodiments, including the illustrated embodiment, internal guide 128 is semi-circular or shaped like an arch that corresponds to the shape of an internal surface of the peripheral wall 105. The internal guide 128 may be positioned proximate open top 110 or in other locations within the body 102, including at any position along the entire height of the body. The internal guide 128 is configured such that tickets of the roll 200 of pre-printed tickets are guided through a guide section 130 between an inward-facing surface of the inner surface of the peripheral wall and an outward-facing surface of the internal guide and through the slot 120 before exiting the body 102. In certain embodiments, the internal guide 128 is biased towards the inner surface of the peripheral wall 106 to apply a compressive force to tickets passing through the guide section 130, which assists in controlling the orientation and speed of tickets that pass out of the body 102 via the slot 120.

In certain cases, the guide section 130 may be provided with a non-slip or gripping element to further control the motion and speed of tickets exiting the body 102. For example, in the illustrated embodiment, one or more protrusions 132 located in the guide section 130 extend away from the internal guide 128 and/or from the inner surface of the peripheral wall 106. These protrusions are configured to contact tickets passing through the guide section 130 to promote controlled extraction of the tickets through the slot 120. In the illustrated embodiment, three protrusions 132 are provided, including a pair of spaced apart protrusions that are each disposed on the internal guide 128 and another protrusion located between the pair of spaced apart protrusions on internal guide when measured in a circumferential direction. Protrusions 132 are preferably sized such that a ticket passing through the guide section 130 is compressed on both sides by them as the internal guide 128 is biased toward the peripheral wall 106.

Next, in certain cases the leading edge of the first outer end 120B of the slot 120 is sharpened to facilitate separating a first ticket of the roll 200 of pre-printed tickets from a second ticket of the roll of pre-printed tickets. To use the sharpened leading edge, tickets may be drawn out of the slot 120 in the direction of the exit angle past first outer end 120B and then drawn counterclockwise (as viewed in FIG. 7B) over the sharpened leading edge. If the tickets are perforated, the edge of first outer end 120B need not be exceedingly sharp. However, if the tickets are not perforated (or even if perforated), a knife edge, such as a metallic cutting edge, may be provided to assist in cutting the rolled strip at a selected length as it exits the slot 120. Of course, in other cases, the second outer end 120E may be sharpened to allow for tickets to be separated by being drawn clockwise (as viewed in FIG. 7B).

Now, with reference to FIG. 1 and FIG. 6A, a plurality of internal ribs 134 (represented as dashed lines in FIG. 1) that each preferably form a continuous loop extending outwards from an inner surface of the body may be provided to facilitate rotation of the roll 200 of tickets and to minimize friction between the inner surface of the body and the tickets. Accordingly, ribs 134 are oriented parallel with the rotational direction of the tickets rotating within the body 102. In the illustrated case, ribs 134 are parallel with the bottom 108. Next, an internal backstop 136 may be provided on an underside of the cap 112. The backstop 136 prevents excess motion of the roll 200 of tickets within the body 102 and correctly positions the roll of tickets within the body such that the tickets are aligned with the slot 120 and are not located in an incorrect location (such as within the cap 112). While, in the illustrated embodiment, only a first backstop 136 is shown in the cap 112 for placement at the open top 110, a second backstop (having similar or different construction, including different height) may be located at the bottom of the body 102 or may be provided in a cap placed over an open bottom of the body.

In this case, the backstop 136 is formed in a 6-pointed star shape having six extensions 138 that radiate outwards from a center point of the underside of the cap 112. Other shapes or configurations are contemplated and the invention is not limited to the specific shape of the backstop 136. Here, a bottom surface of each extension 138 is configured to contact a top of the roll 200 of tickets 200A to control movement of the tickets within the body 102. Based on the height of body 102, the internal space 104, and the roll 200 of tickets 200A, the height of each extension 138 is set to enable the roll of tickets to rotate within the body while also maintaining alignment of the tickets with the slot 120. The height of the top extension 138 is measured as the distance from each extension's connection to the cap to the bottom surface of the extension. The height of the bottom extension 138 is measured as the distance from each extension's connection to the bottom cap to the top surface of the extension.

The dispenser 100 may be configured to accept a variety of tickets having different heights while still using the same body 102. This may be accomplished by replacing one cap 112 having extensions 138 with a first height with a different cap having extensions with a different height. Alternatively, it may also be possible to provide a removable extension 138 that can be removed from the cap 112. In that case, extensions 138 having different heights may be used to accommodate rolls 200 of tickets having a variety of heights. In still further embodiments, it may be possible to connect two or more extensions 138 together with each other and with the cap 112, such as by snap connections, to provide an extension having a customizable height.

Referring again to FIGS. 1-3, in certain embodiments, a finger cutout 140 is formed in the peripheral wall 106 at the guide section that permits a user to contact a portion of a ticket passing out of the body 102 while a portion of the ticket is in the guide section. The finger cutout 140 is disposed over the internal guide 128 such that a ticket passing out of the body 102 through the guide section provides a free end 206 (FIG. 3) may be contacted by the user at the finger cutout while the other end of the ticket is compressed between the internal guide 128 and the peripheral wall 106. In FIG. 3, a pair of free ends 206A, 206B is shown. Once the ticket shown on the right is removed from the body 102 using free end 206A, the ticket shown on the left may be drawn out of the body 102 by grasping free end 206B. During this process, a user may contact a portion of the ticket 200A at the finger cutout 140, which would assist the user in extracting the ticket. In certain embodiments, outside surface of the peripheral wall 106 may provide directional guides 142 for guiding tickets through the guide section 130 and out of the slot 120. In the illustrated embodiment, directional guides 142 are formed as several parallel notches or channels that are provided in the outside surface of the peripheral wall 106 and that are oriented in circumferential direction so as to encourage movement of the tickets around the body 102 and over the outside surface of the internal guide 128.

Next, the top of the cap 112 may be provided with a connector 144, such as a carabiner (FIG. 2A), to enable the body 102 and cap to be attached to a desired mounting location. In the illustrated case, connector 144 is inserted through an opening 146 formed in a tab 148 that extends vertically from the top of and is formed as a single component with the cap 112. This same opening 136 would permit other forms of fasteners, such as ropes, hooks, etc. to be attached to the cap 112. Additionally or alternatively, other connectors may also be disposed on the body 102 as well. In this case, a pair of receivers 150 is formed as part of the body 102. Each of these receivers is configured to capture and securely hold connector 152, such as a belt clip, which is preferably removably inserted into the receiver. For example, one or more detents 154 may be provided within a slot 156 formed in each receiver 150. Of course, other suitable connectors may be used in place of the belt clip/detent.

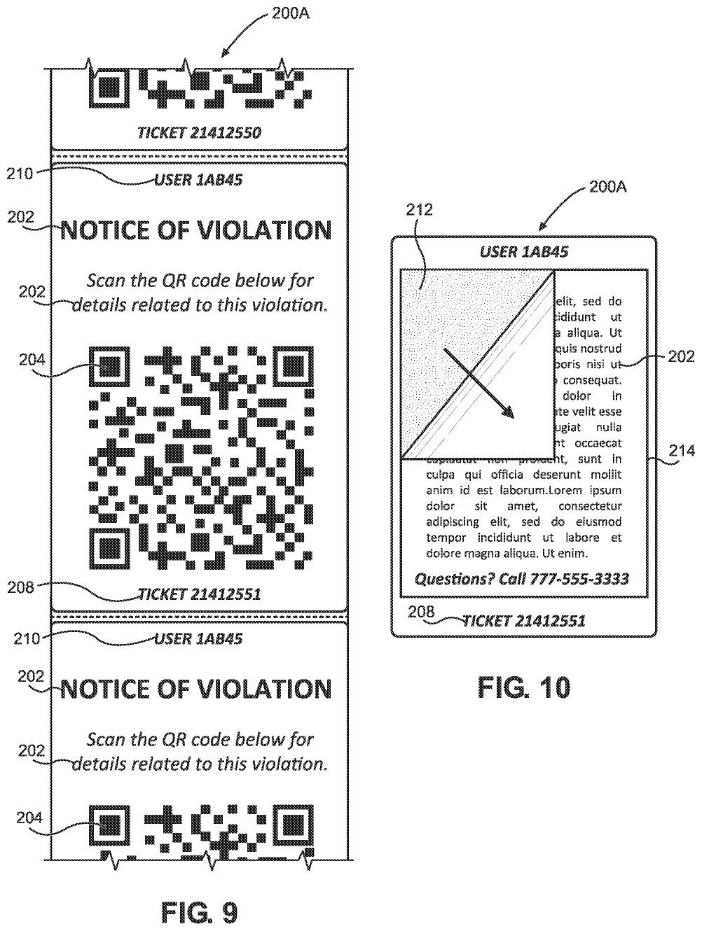

In FIGS. 9 and 10, an example ticket 200A that may be used in connection with the system and methods disclosed herein is shown. The perforated tickets 200A are each provided in a physical form having pre-printed content including human-readable content 202 and machine-readable content 204. Additionally, each ticket 200A is preferably associated with a unique identifier 208 that is specific and unique to each ticket. In the illustrated embodiment, unique identifier 208 is represented as a ticket number (i.e., “TICKET 21412551”). However, any convenient methods for uniquely grouping, separating, and identifying tickets may be used, including color coding, barcodes, quick response (QR) codes, alphanumeric or symbolic devices, etc. Additionally, a user identification 210 for the entity issuing the ticket 200A may be included. Next, in certain embodiments, a rear (or front) surface of each ticket 200A includes an adhesive 212 that is configured to permit the ticket to be removably attached to a surface such as the windshield of a vehicle. A removable cover 214 for the adhesive, such as a removable paper cover, may provide human-readable content 202 such as directions, a phone number, a website, etc. for paying a fine, contacting the company issuing the ticket, etc.

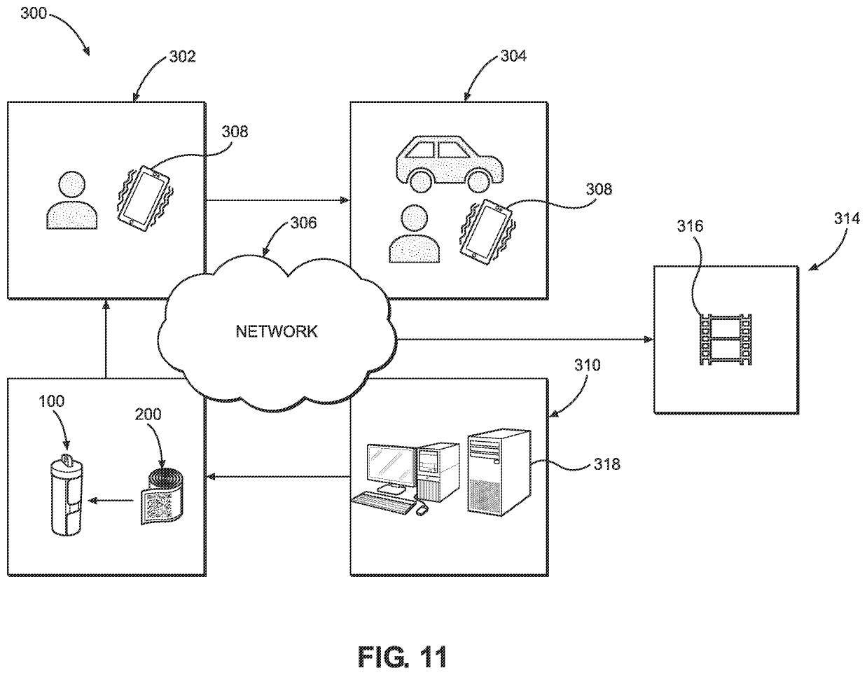

Finally, FIG. 11 provides a diagram illustrating an example of a system 300 that may be used in connection with ticketing dispenser 100 to issue, track, and process tickets that are preferably obtained from a roll 200 of tickets. More particularly, FIG. 11 provides a diagrammatic representation of a ticket provider 310 that preferably provides the ticket dispenser 100 and rolls 200 of tickets, a ticket user 302 that receives the ticket dispenser and rolls from the ticket provider and then issues tickets, and a ticket client 304 that receives the tickets issued by the ticket provider. Communication between the ticket provider 310, ticket user 302, and ticket client 304 is made possible by a network 306, such as a wired or wireless network, including the Internet, which allows for the communication of information from one entity to another entity.

The tickets are provided by the ticket provider 310 to the ticket user 302 in a pre-printed format having pre-printed content including human-readable content and machine-readable content. Throughout the entirety of the issuance and subsequent use process of the tickets, no modification of the pre-printed information or modification of a physical format of the tickets with other than pre-printed information is required, including by the ticket user 302 or ticket client 304. Rolls 200 of tickets are preferably provided by ticket provider 310 to a ticket user 302 in a non-activated ticket state and are activated only when issued by the ticket user. Later, after the ticket has been used or the matters concerning the ticket have been completed, the status of the ticket may be updated to de-activated, no longer activated, closed, etc. Among other things, this allows the status of tickets to be tracked automatically by the system and for replacement tickets to be ordered and received in a timely manner by the ticket user 302.

Each ticket that is provided by the ticket provider 310 to a ticket user 302 is preferably associated with one or more accounts (e.g., digital records) when provided by the ticket provider. These accounts preferably store information related to each of the tickets that is viewable by the ticket provider and/or the ticket user. In at least one or more of these accounts, the total number of tickets (i.e., a “count”) provided by ticket provider 310 to ticket user 302 is preferably tracked along with the status of each ticket (e.g., non-active, active, etc.). In certain cases, each time a status change is made to a ticket, these counts are adjusted accordingly. For example, each time a ticket is activated (i.e., issued), the count of non-activated tickets is reduced and the count of activated tickets is increased.

This information might be automatically stored, for example, in an electronic storage 318 associated with the ticket provider 310 in response to tickets being provided to a ticket user. For new ticket users, the creation of a ticket user account might occur, for example, when the tickets are purchased and then provided by the ticket provider. For returning customers, the same account may be used to track further ticket purchases and their use over time. Through this account, the ticket user 302 and, in at least certain preferred cases, the ticket provider 310 can view the total number of tickets have been purchased, the number of tickets that are not active (i.e., have not been issued), active (i.e., issued and outstanding), and no longer active. Advantageously, tracking tickets in this manner would permit a new roll 200 of tickets to be requested from and provided by the ticket provider 310 to the ticket user 302 in a timely manner before the previously provided roll(s) of tickets are expended. This might occur, for example, at a pre-determined time interval or when the number of non-active tickets falls below a certain minimum threshold or the number of active and/or no longer active tickets surpasses a certain threshold.

After being provided with dispenser 100 and roll 200 and then loading the tickets into the body of the dispenser, as discussed above, a ticket user 302 is ready to begin issuing the tickets. To issue the tickets, the ticket user 302 extracts a first ticket from the dispenser 100 and then enters a unique identifier associated with that first ticket into a user device 308, such as a tablet or mobile phone. Preferably this information is entered into a mobile application on the mobile device 308 that is provided by the ticket provider 310 or that is otherwise compatible with the system 300. This application preferably allows the ticket user 302 to capture information and to directly associate that information with one of the tickets being issued, including by capturing text, other media (e.g., images, video, sound), or other data (e.g., positional/GPS data).

The unique identifier can be entered by hand but, more preferably, is entered simply by imaging the machine-readable content (e.g., a QR code) that is pre-printed on the ticket and that is associated with the unique identifier using a camera of the user device. Entering the unique identifier into the user device 308 preferably creates a record for the ticket that is then associated with one or more of the accounts discussed above. It would also give the ticket user 302 an opportunity to associate different information with that unique identifier and to save that information in the record associated with that ticket and unique identifier. For example, scanning the QR code on a non-active ticket using an application on the user device 308 might cause a window to open or to be displayed on the user device that gives the ticket user 302 an option to activate the ticket and to issue it after entering the relevant information via the device. To complete the ticket issuance process, so that additional relevant information may then be provided to the system and that information is then associated with the unique identifier. Preferably, the ticket user 302 would then be provided with an opportunity to view, add/remove, or modify information into the user device 308 and to have that information associated with the ticket and stored in the associated record(s). In certain embodiments, interacting with a ticket in this manner automatically causes its status in the accounts described above to be updated from a non-activated ticket state to an activated ticket state and to be considered “issued.”

Once issued, the tickets are updated from the non-activated state to an activated state. This change might be reflected in the accounts mentioned above. Capturing and tracking this data in one or both accounts would allow the ticket provider and/or ticket user to track each of the tickets that have been provided to the ticket user and that have/have not been issued. This would allow for replacement roll of tickets to be provided by the ticket provider to the ticket user in a timely manner that preferably avoids an outage where tickets are not readily available for issuance by the ticket user. As discussed above, the timing for re-ordering tickets might be based on the number of tickets issued or not issued. Additionally, the timing for re-ordering tickets might be dynamically updated based on the rate of their issuance based on information captured from the ticket user.

When issuing a ticket, a user is not required to modify the information printed on the tickets themselves in any way. In particular, the ticket user 302 does not modify existing printed content or add new printed content to the ticket. For example, unlike conventional systems, a ticket user 302 is not required to write down information about an illegally parked vehicle (e.g., VIN or license number) on the ticket itself, which conventionally slows the issuance process. Instead, this information is collected and then stored electronically in the electronic records discussed above and each of the tickets is already pre-printed with means for accessing that electronic record and all the information associated with the ticket. As a result, using only a user device 308, a ticket user 302 can capture all the information needed to complete and issue the ticket.

As a more specific example, if this system 300 is in use by a parking attendant, the parking attendant might extract a ticket from the dispenser 100, scan a QR printed on the ticket in order to create a record for that specific ticket, and then enter information related to an illegally parked vehicle, the time/date and location of the offense, etc. into the user device 308. The information entered is then automatically associated with the record that was automatically created for that ticket in one or more accounts that preferably make some or all of the information collected available to the ticket provider 310, ticket user 302, and ticket client 304. Advantageously, the adhesive 212 (see FIG. 10) would permit the ticket 200A to then be removably attached to a surface, such as a windshield of an offending vehicle.

Upon returning to their vehicle, the vehicle operator (i.e., the ticket client 304) could then use their own mobile device 308 to scan the QR printed on the ticket to access a record associated with the ticket. The ticket client 304 might then be provided with access to information related to the offense that was previously captured by the ticket user 302. If a financial obligation has been incurred (e.g., a monetary fine), the ticket client 304 would preferably be able to view and make a payment through the mobile application to satisfy that obligation or to provide other input or information, including disputing a charge with the ticket user 302. If the ticket received is not the first for a particular ticket client 304, the account created for that ticket client will preferably be updated each time a new ticket is issued or a change is made to a previously-issued ticket. In preferred embodiments, similar changes may also be made to accounts for the ticket provider 310 and ticket user 302 as well. Therefore, not only does this system 300 permit the issuance of printerless tickets but it also allows for those tickets and for each of the accounts to be updated dynamically over time.

In certain embodiments, the system 300 is also configured to communicate with other systems 314 and to provide and/or receive information from those systems that might be relevant to the ticket provider, ticket user or the ticket client. For example, the dispenser 100 (or another similar device for issuing tickets) might be used as a mobile kiosk for issuing event tickets 316 where a printer is unavailable. In that case, information concerning the availability, location, and price of tickets 316 to the event would preferably be updated in real time and available from those other systems 314 to the ticket user or ticket client via the user device 308. An event patron could then purchase a ticket 316 from the mobile kiosk and be provided with a pre-printed ticket that is associated with the details related to the event, including the show time and the person's assigned seat. Later on, by imaging at least a portion of the machine-readable content of the ticket 316 or by inputting a unique identifier associated with the ticket into a user device 308, a ticket client is provided with at least a portion of the information associated with that ticket. For example, in the case of a concert, by interacting with the ticket 316, authorization to enter or to attend the event could be verified. In another case, the dispenser 100 could be used to issue airline or other forms of tickets 316 without the use of a printer. In each of these cases, the location of the seat that had been purchased might be viewable through the mobile application. In these cases, the ticket client could be a person purchasing the event ticket or may be an usher at an event location, either having mobile device 308 with which they may interact with ticket 316. The tickets 316 in these cases might be used to verify admittance and then direct the attendant to their assigned seat. The mobile application could also be used to track the attendant's current location and then provide visual guidance (e.g., a map shown on a mobile phone) to the person's assigned seat. Additionally, if aspects of the event, such as the gate for boarding an airplane, are updated those details can be modified and shown, preferably in real time, by interacting with other systems 314 and the ticket 316 in the manner discussed above.

In another use case, the tickets could be used as postage for mailing letters, parcel, or packages. In this case, the ticket user 302 might be a consumer that purchases a roll 200 of stamps that are pre-printed with a QR code. By scanning the QR code of one stamp using a mobile phone, an intended destination can be entered into the mobile phone application, which would then be associated with the QR code. The amount of postage needed could also be determined at that time, including by weighing the parcel (using a separate scale), and then payment could be made via the mobile phone application. Other information could also be associated with the QR code, including the identity of the sender, special handling conditions, instructions to the mail carrier, etc. Later on, using the machine-readable and/or human-readable content, a ticket client (e.g., a postal worker or postal sorting machine) can verify or retrieve some or all of the information associated with the QR code by scanning it, including: (1) that sufficient postage has been paid and (2) that the address provided by scanning the QR code (i.e., the machine-readable content) matches the printed address (i.e., the human-readable content). An advantage of the present systems and methods is that the single QR code also allows for the associated information to be updated at any time. So, in the case above, the intended delivery address might be updated in certain cases from the one entered by the ticket user (i.e., the person sending the parcel). This might occur, for example, if the original destination is associated with a mail forwarding address. In that case, the address entered by the ticket user might be updated automatically or a different address might be suggested to and confirmed by the ticket user before the update is made.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A ticket dispenser comprising:
a body having an internal space defined by peripheral wall and a closed bottom located at one end of the peripheral wall, wherein the internal space is sized and configured to hold a roll of pre-printed tickets;
an open top of the body located at an end of the peripheral wall opposite the closed bottom;
a cap configured to removably mount over the open top to secure the roll of pre-printed tickets within the internal space;
a slot formed in the peripheral wall of the body that is sized and configured to permit the roll of pre-printed tickets to be unrolled within the internal space by guiding a free end of the roll of tickets through the slot.

2. The ticket dispenser of claim 1 wherein the slot is formed by a first slot portion having a first slot surface with a first outer end and first inner end and a second slot portion having a second slot surface with a second outer end and second inner end,
wherein:
the first slot surface is parallel with a first plane that is oriented at a first angle with respect to a tangential plane centered between the first outer end and the second outer end, and
the second slot surface is parallel with a second plane that is oriented at a second angle with respect to the tangential plane.

3. The ticket dispenser of claim 2 wherein the slot is oriented such that tickets pass out of the body via the slot by passing between the first slot surface and second slot surface at an exit angle of between 5° and 50° with respect to the tangential plane.

4. The ticket dispenser of claim 2 wherein the first angle and second angle are different such that an outer slot opening size measured in a circumferential direction between the first and second outer ends is greater than an inner slot opening size measured in said circumferential direction between the first and second inner ends.

5. The ticket dispenser of claim 2 wherein an edge of the first outer end is sharpened to facilitate separating a first ticket of the roll of pre-printed tickets from a second ticket of the roll of pre-printed tickets.

6. The ticket dispenser of claim 1 further comprising an internal guide mounted to an inner surface of the peripheral wall proximate the slot that extends into the internal space, wherein the internal guide is configured such that tickets of the roll of pre-printed tickets are guided through a guide section between an inward-facing surface of the inner surface of the peripheral wall and an outward-facing surface of the internal guide and towards the slot.

7. The ticket dispenser of claim 6 wherein the internal guide is biased towards the inner surface of the peripheral wall to apply a compressive force to tickets passing through the guide section.

8. The ticket dispenser of claim 7 further comprising at least one protrusion that is disposed in the guide section extending away from the internal guide or from the inner surface of the peripheral wall and that is configured to contact tickets passing through the guide section.

9. The ticket dispenser of claim 8 wherein the at least one protrusion comprises three protrusions, including a pair of spaced apart protrusions that are each disposed on either the internal guide or the inner surface of the peripheral wall and a protrusion disposed between the pair of spaced apart protrusions on the other one of the internal guide or the inner surface of the peripheral wall.

10. The ticket dispenser of claim 8 further comprising a finger cutout formed in the peripheral wall at the guide section that permits a user to contact a portion of a ticket passing out of the body while a portion of the ticket is in the guide section, wherein the finger cutout is disposed over the internal guide such that the ticket passing out of the body and contacted by the user at the finger cutout is configured to be compressed against the internal guide.

11. The ticket dispenser of claim 1 further comprising said roll of pre-printed tickets, wherein each ticket:
is associated with a unique identifier;
is in a physical format;
includes pre-printed content including human-readable content and machine-readable content, wherein the machine-readable content is configured to cause information to be displayed on a user device when the machine-readable content of the ticket is imaged by the user device; and
includes an adhesive configured to permit the ticket to be removably attached to a surface.

12. A method for operating a ticketing system comprising the steps of:
providing a first plurality of tickets to a ticket user in a physical format and including pre-printed content including human-readable content and machine-readable content, wherein each ticket is associated with a unique identifier;
providing a computer-based platform that is accessible over a network using a plurality of user devices, wherein the platform is associated with at least one electronic storage configured to store user information for one or more ticket users, client information for one or more ticket clients and ticket information for one or more tickets;
within the platform, associating each of the first plurality of tickets with a user record for the ticket user in the at least one electronic storage;
within the platform, in response to a user issuing a first ticket of the first plurality of tickets by (i) imaging at least a portion of the machine-readable content of a first ticket of the first plurality of tickets with one of the plurality of user devices or (ii) inputting the unique identifier into the platform via an input of one of the plurality of user devices and inputting client information into the platform via the input, automatically creating or updating a client record in the at least one electronic storage that associates at least a portion of the client information input by the user with the unique identifier of the first ticket and updating the user record, wherein the ticket is issued without requiring modification of the pre-printed information or the physical format of the first ticket with other than pre-printed information;
within the platform, in response to (i) a portion of the machine-readable content of a first ticket being imaged with one of the plurality of user devices or (ii) the unique identifier being input into the platform with one of the plurality of user devices, displaying at least a portion of the client record on the user device.

13. The method of claim 12 wherein a financial obligation is associated with the client and the client record, the method further comprising the step of accepting payment via the platform and then applying the payment to the financial obligation.

14. The method of claim 12 wherein each of the first plurality of tickets is provided in a non-activated ticket state and wherein each of the first plurality of tickets is configured to be updated from the non-activated ticket state to an activated ticket state when the ticket is issued.

15. The method of claim 14 wherein a count of non-activated tickets is associated with a user account, wherein the count of non-activated tickets is reduced each time a ticket is activated, the method further comprising the step of automatically providing a second plurality of tickets to the ticket user in a non-activated ticket state and in response to the count of non-activated tickets falling below a pre-determined minimum.

16. The method of claim 12 further comprising the step of automatically updating the client record within the platform in response to a second ticket being issued that is associated with client information related to the client.

17. A method for issuing a ticket using a ticketing system, the method comprising the steps of:
accessing a plurality of tickets that are provided in a physical format and that include pre-printed content including human-readable content and machine-readable content, wherein each ticket is associated with a unique identifier; and
issuing a ticket that associates client information for a first client with the unique identifier of a first ticket of the plurality of ticket in an electronic storage by (i) imaging at least a portion of the machine-readable content of a first ticket of the first plurality of tickets with a user device or (ii) inputting the unique identifier into a computer-based platform that is accessible over a network via an input of the user device and inputting client information into the platform via the input, wherein issuing a ticket automatically creates or updates a client record associated with the client and the unique identifier of the first ticket and creates or updates a user record associated with the user and the unique identifier of the ticket, wherein the ticket is issued without requiring modification of the pre-printed information or the physical format of the first ticket with other than pre-printed information.

18. The method of claim 17 wherein each of the plurality of tickets is provided with an adhesive configured to permit the ticket to be removably attached to a surface, the method further comprising the step of removably adhering the ticket to said surface with the adhesive.

19. The method of claim 17 further comprising the step of loading the first plurality of tickets into a ticket dispenser having: a body having an internal space defined by peripheral wall and a closed bottom located at one end of the peripheral wall, wherein the internal space is sized and configured to hold the first plurality of tickets; an open top of the body located at an end of the peripheral wall opposite the closed bottom; a cap configured to removably mount over the open top to secure the first plurality of tickets within the internal space; and a slot formed in the peripheral wall of the body that is sized and configured to permit the first plurality of tickets to be unrolled within the internal space by guiding a free end of the first plurality of tickets through the slot.
